(19) United States
(12) Patent Application Publication
(10) Pub. No.: US 2015/0257572 A1
(43) Pub. Date: Sep. 17, 2015

(54) STEAM SENSOR FOR COOKING DEVICES

(71) Applicant: Convotherm Elektrogeraete GmbH, Eglfing (DE)

(72) Inventor: Guenter Wurdinger, Peibenberg (DE)

(73) Assignee: Convotherm Elektrogeraete GmbH, Eglfing (DE)

(21) Appl. No.: 14/206,719

(22) Filed: Mar. 12, 2014

(51) Int. Cl. A47J 27/04; A23L 1/01; A47J 27/62

(52) U.S. Cl. CPC A47J 27/04; A47J 27/62; A23L 1/0121; A47J 2027/043

(57) ABSTRACT

Disclosed are cooking devices and methods for measuring and controlling the humidity content using a temperature/humidity probe in the cooking devices. The temperature/humidity probe operates in a closed system so that heat and humidity is not lost excessively to the outside environment. The temperature/humidity probe confers energy savings and efficiency to the operation of the cooking devices. One embodiment provides a closed system in which the end of a drain pipe disposed between the cooking chamber of the cooking device and a condenser outside of the cooking chamber is below a water level in the condenser so as to form a closed system such that heated and humid air in the cooking chamber cannot exit the cooking chamber without passing through the water level, and the temperature/humidity probe is disposed in the condenser in an air space above the water level and proximal the drain pipe.

### BACKGROUND

1. Field of the Disclosure

The present disclosure relates to cooking devices and methods for measuring and controlling the maximum steam content of the cooking devices. More particularly, the present disclosure relates to steam sensors for cooking devices that operate as part of a closed system so that heat and steam is not lost excessively to the outside environment. The steam sensor of the present disclosure confers energy savings and efficiency to the operation of the cooking devices.

2. Background of the Disclosure

The quantity of steam inside the cooking chamber of a cooking device is an important parameter for achieving good cooking results. Thus, measuring and controlling the quantity of steam inside the cooking chamber of a cooking device can be a critical feature of a cooking device and of the quality of the cooked food product. According to the state-of-the-art, many different types of humidity probes and steam sensors are used in commercial cooking devices, such as a commercial combisteamer. Commercial combisteamers generally use steam, hot air or a combination of heat and steam to heat or cook the food product that has been placed in the cooking device. Thus, in the state-of-the-art various devices have been developed to attempt to measure and control the humidity in the cooking chamber of the cooking device so that the food product is properly cooked. Typically, however, as will be seen by the review of this state-of-the-art devices, below, the devices in use, to measure and control the steam or humidity, respectively, in the cooking chamber of the cooking device are located such that servicing and cleaning of the devices is difficult and/or the devices are used in “open” systems that allow for escape of the heated, humid air from the cooking chamber to the outside environment, leading to wasted resources and excessive cost. Some embodiments of the state-of-the-art will be discussed below.

EP 1847203 describes a cooking device that has a steam outlet sensor. The steam outlet sensor includes a first opening that leads to the interior of a protective housing located in a pressure chamber that is exposed to the outside environment. Located in the interior of the protective housing is a temperature sensor that measures a temperature Tₓ. If, for example, the temperature Tₓ read by the temperature sensor falls below a lower threshold temperature Tₛ1, a steam generator is turned on to provide steam to the cooking chamber. On the other hand, if the temperature Tₓ read by the temperature sensor reaches an upper threshold Tₛ2, steam is withdrawn from the cooking chamber. However, the first opening that leads to the protective housing in which the temperature sensor is located is always open and exposed to the outside environment. Therefore, the uncontrolled release of heated, humid air from the cooking chamber cannot be avoided.

EP 0092851 describes a cooking device that has a small cross-sectional measuring line that connects the cooking chamber to an exhaust line leading to the outside environment. There is a temperature sensor located in the small cross-sectional measuring line proximal to the exhaust line leading to the outside environment. The temperature sensor monitors the temperature of the gases departing the cooking chamber, and when a sufficient temperature is detected, the heating element for the steam generator is turned off. In any event, the small cross-sectional measuring line and the temperature sensor therein connect the cooking chamber to the outside ambient environment at all times. Moreover, the temperature sensor, located in the small cross-sectional measuring line is difficult to service and clean.

EP 2474787 is similar to EP 1847203. In EP 2474787, a temperature sensor is located between an opening in the cooking chamber (that is always open) of the cooking device and an opening that provides egress of cooking chamber gasses to the outside ambient atmosphere. As an overpressure occurs in the cooking chamber due to the production of steam, excess steam, due to the overpressure, escapes through the opening in the cooking chamber, the temperature sensor detects the temperature of the escaping steam that is vented to the outside atmosphere, and adjusts the steam production. Thus, EP 2474787 likewise, controls steam production in an open system that vents steam due to overpressure to the outside ambient environment.

U.S. Patent Application Publication Number 2012/0294992 discloses a humidity sensing arrangement for actively evaluating the humidity within the cooking chamber of the cooking device. In the embodiments shown, the humidity sensing arrangement is in direct communication through an open passage with the cooking chamber and in another embodiment, the humidity sensing arrangement is, further, located along an exhaust path leading to the outside ambient environment.

U.S. Pat. No. 6,987,246 discloses a humidity control system for a combination oven, using a temperature sensor disposed outside of, and not in direct communication with, the cooking chamber of the combination oven. However, the temperature sensor is located in the pathway of a bypass tube that is vented outside of the cooking chamber to the ambient atmosphere. Also, in the embodiment of this patent, when there is an overpressure in the cooking chamber due to excess steam, an outlet valve opens and vents hot, humid air to the outside ambient environment.

As can be seen from the above state-of-the-art, the humidity/steam control devices/systems are employed in systems that continuously vent humid air to the outside environment. These systems waste energy and cause unnecessary heat losses. Also, many of the state-of-the-art systems place the temperature sensor or a humidity sensor in a position that prevents easy cleaning and/or maintenance/replacement of the temperature sensor or humidity sensor.

### SUMMARY

It is an object of the present disclosure to improve the known cooking devices by providing a method/device for controlling steam production without continuous heat losses to the ambient environment.

It is also an object of the present disclosure to improve the known cooking devices by providing a method/device for controlling steam production while minimizing energy consumption.

It is a further object of the present disclosure to improve the known cooking devices by providing a device for controlling seam production in a cooking chamber that has low manufacturing costs associated with its inclusion in the cooking device.

It is a still further object of the present disclosure to improve the known cooking devices by providing a device for controlling steam production in a cooking chamber that is easy to clean and, preferably, can be cleaned at the same time as the cleaning cycle of the cooking chamber itself.

Thus, the benefits provided by the present disclosure include lower manufacturing costs for the steam production controlling device included in the cooking device, better and easier cleaning of the steam production controlling device, and increased reliability and reduced space requirements of providing the steam production controlling device in the cooking device.

One embodiment according to the present disclosure provides a cooking device having a cooking chamber, a drain pipe having two ends, one end disposed in communication with the cooking chamber and the other end disposed in communication with a condenser located outside of the cooking chamber, the condenser having a water level therein, the water level forming a water barrier, a waste water pipe, a vent pipe leading from the condenser to the outside environment and a temperature sensor for detecting a temperature in communication with the steam generator via a controller, the cooking device characterized in that

the end of the drain pipe disposed in communication with the condenser is below the water barrier so as to form a closed system such that heated and/or humid air in the cooking chamber cannot exit the cooking chamber without passing through the water barrier, and

the temperature sensor is disposed in the condenser in an air space above the water level and proximal the drain pipe.

Preferably, the cooking device is characterized in that when the temperature sensor detects a pre-determined lower temperature in the air space, the temperature sensor, via the controller, activates the steam generator to produce and provide steam to the cooking chamber (if required), and when the temperature sensor detects a predetermined upper temperature in the air space, the temperature sensor deactivates the steam generator via the controller to cease producing and providing steam to the cooking chamber.

Also preferably, the temperature sensor is disposed in the air space above the water level from about 10 mm to about 80 mm from the drain pipe. Also preferably, the temperature sensor may be shielded so that it does not come into contact with the water level. In addition, in a preferred embodiment, the predetermined upper temperature is from about 0.5K to about 20K greater than the predetermined lower temperature, more preferably, the predetermined upper temperature is from about 1K to about 5K greater than the predetermined lower temperature.

Another embodiment according to the present disclosure provides a process for operating a cooking device having a cooking chamber, a steam generator in direct communication with the cooking chamber, a drain pipe having two ends, one end disposed in communication with the cooking chamber and the other end disposed in communication with a condenser located outside of the cooking chamber, the condenser having a water level therein, the water level forming a water barrier, a waste water pipe, a vent pipe leading from the condenser to the outside environment, and a temperature sensor for detecting a temperature in communication with the steam generator via a controller, the process characterized by

providing that the end of the drain pipe disposed in communication with the condenser is below the water barrier so as to form a closed system such that heated and humid air in the cooking chamber cannot exit the cooking chamber without passing through the water barrier,

providing that the temperature sensor is disposed in the condenser in an air space above the water level and proximal the drain pipe,

starting a cooking cycle in a steam mode for cooking a food product in the cooking chamber,

starting the steam generator to provide steam to the cooking chamber,

allowing excess steam to exit the cooking chamber via the drain pipe and through the water barrier when the cooking chamber is filled with steam,

measuring the temperature of the air space by the temperature sensor,

stopping the steam generator when the temperature sensor detects a predetermined upper temperature in the air space, and

starting the steam generator when the temperature sensor detects a predetermined lower temperature in the air space.

In a preferred embodiment, the stopping of the steam generator when the temperature sensor detects a predetermined upper temperature in the air space and the starting the steam generator when the temperature sensor detects a predetermined lower temperature in the air space occurs at a predetermined upper temperature of from about 0.5K to about 20K greater than the predetermined lower temperature and, more preferably, at a predetermined upper temperature of from about 1K to about 5K greater than the predetermined lower temperature. Also preferably, method is further characterized in that the temperature sensor is shielded so that it does not come into contact with the water level.

### BRIEF DESCRIPTION OF THE DRAWINGS

Further details, features and advantages of the present disclosure will result from the following description of embodiments using the drawings in which:

FIG. 1 shows a schematic representation of a state-of-the-art combisteamer with a temperature sensor for steam control located in a by-pass channel;

FIG. 2 shows a schematic representation of an embodiment of a combisteamer with a temperature sensor for steam control of the present disclosure;

FIG. 3 shows a schematic representation of a process flow chart of the process steps of a temperature sensor for steam control according to the present disclosure;

FIG. 4 shows a schematic representation of an alternative process flow chart of the process steps of a temperature sensor for steam control according to the present disclosure.

### DETAILED DESCRIPTION OF THE PREFERRED EMBODIMENTS

The present disclosure will now be described in detail with respect to the embodiments shown in the Figures, in which like numerals represent like elements.

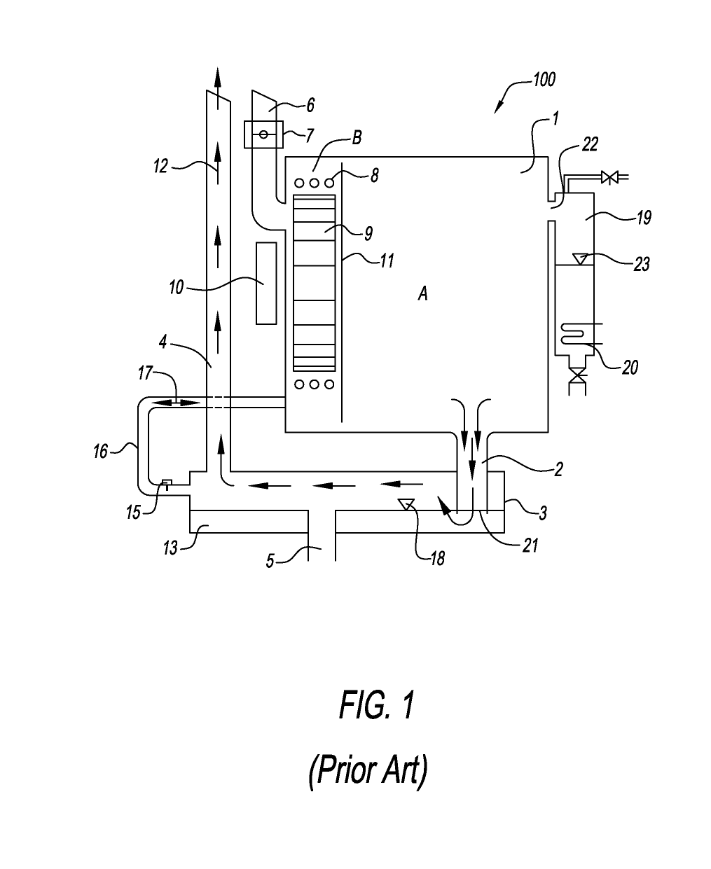

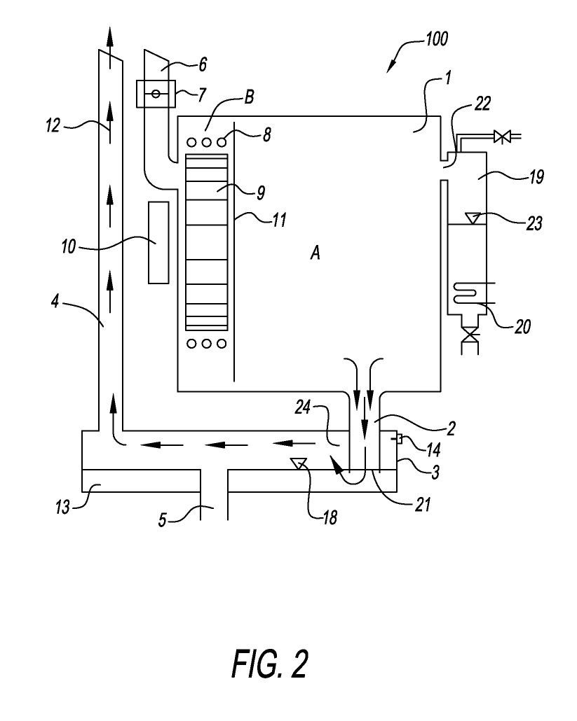

FIG. 1 shows a generalized design of a state-of-the-art combisteamer 100 having a steam sensor and control (not shown). In FIG. 1, combisteamer 100 has a cooking chamber 1, a drain pipe, 2, a condenser 3, a vent pipe. 4, a waste pipe 5, and air inlet pipe. 6 and an air inlet flap 7. Cooking chamber 1 contains heating elements 8, a fan 9 driven by a motor 10, and a panel 11 that separates cooking chamber 1 into a cooking zone A and a heating zone B made up of fan 9 and heating elements 8. Condenser 3 has a water level 18 therein and the water level 18 provides a water barrier 21 between the cooking chamber 1/drain pipe 2 and vent pipe 4. The depth of water level 18 is controlled by the height that waste pipe 5 protrudes into condenser. Air inlet pipe 6 allows for cooler air from the outside environment to enter cooking chamber 1 for dehumidification purposes when air inlet flap 7 is open. Combisteamer 100 is also provided with a steam generator 19 that includes a heating element 20 disposed in a water level 23 such that when steam is demanded for a cooking cycle, heating element 20 heats the water to produce steam that enters into cooking chamber 1 via opening 22. Although steam generator 19 is shown as a separate unit in FIGS. 1 and 2, the steam generator could be replaced with a water line that sprays water directly into heating zone B, as is known in the art. Heated, humid air from cooking chamber 1 generally flows down drain pipe 2 and into condenser 3, following the arrows depicted in FIG. 1 when there is sufficient pressure in the cooking chamber. Thereafter, heated, humid air exits via vent pipe 4, also following arrows 12. The steam sensor of combisteamer 100 is comprised of temperature sensor 15 and bypass pipe 16. Bypass pipe 16 is so-called because, as will now be described, it allows excess steam in cooking chamber 1 to bypass water level 18 in condenser 3. When the pressure in cooking chamber 1 is below a certain threshold level (or in an “under pressure” state), bypass pipe 16 allows airflow in the direction from left to right as shown by double-headed arrow 17, i.e. into cooking chamber 1. During a cooking cycle in which steam is provided by steam generator 19, the pressure in cooking chamber 1 gradually increases. However, as the pressure in cooking chamber 1 increases, the high pressure, high humidity air in cooking chamber 1 proceeds along double-headed arrow 17 from right to left (this being the “path of least resistance” as compared to air flow down drain pipe, 2 and across and through water barrier 21). As hot, humid air from cooking chamber 1 proceeds in a direction double-headed arrow 17 from right to left it, passes through bypass pipe 16, and escapes through a vent pipe 4. In this manner, hot, humid air is wasted, as well as energy consumption is increased. In addition, the location and size of bypass pipe 16 makes it difficult to access and clean.

FIG. 2 shows an embodiment of a combisteamer 100 having a steam sensor and control according to the present disclosure. In FIG. 2, bypass pipe 16 and temperature sensor 15 of FIG. 1 have been removed, thus also removing the bi-directional airflow of double-headed arrow 17. According to the present disclosure, temperature sensor 14 has been placed in the airspace 24 above water level 18 and water barrier 21. As can also be seen, temperature sensor 14 has been placed proximal to drain pipe 2. The impact of these modifications on the function of the temperature sensor and control will become apparent to those of skill in the art based upon the following description. As a cooking cycle requiring steam is commenced and steam generator 19 provides steam to cooking chamber 1, the pressure in cooking chamber 1 gradually increases. At first, steam from steam generator 19 condenses on the cooler surfaces of the food product being cooked in cooking chamber 1. At some point during the cooking cycle, the steam provided to cooking chamber 1 by steam generator 19 condenses more slowly than the new steam is produced. At this point, the pressure in cooking chamber 1 builds to a point where excess steam is forced down drain pipe 2. At the same time, temperature sensor 14 detects an increase in the temperature in airspace 24 due to the pressurized steam exiting cooking chamber 1. When temperature sensor 14 detects a temperature at a pre-determined upper level, temperature sensor 14 sends a signal to steam generator 19 via the controller to shut off and stop producing and providing steam to cooking chamber 1. As steam generator 19 stops producing and providing steam to cooking chamber 1, at a subsequent time, the gases escaping from cooking chamber 1 through drain pipe 2 stop. This causes the temperature in the drain pipe to be at a lower temperature and temperature sensor 14 detects that temperature as well. When temperature sensor 14 detects a predetermined lower temperature, temperature sensor 14 now signals steam generator 19 via the controller to again begin producing and providing steam to cooking chamber 1.

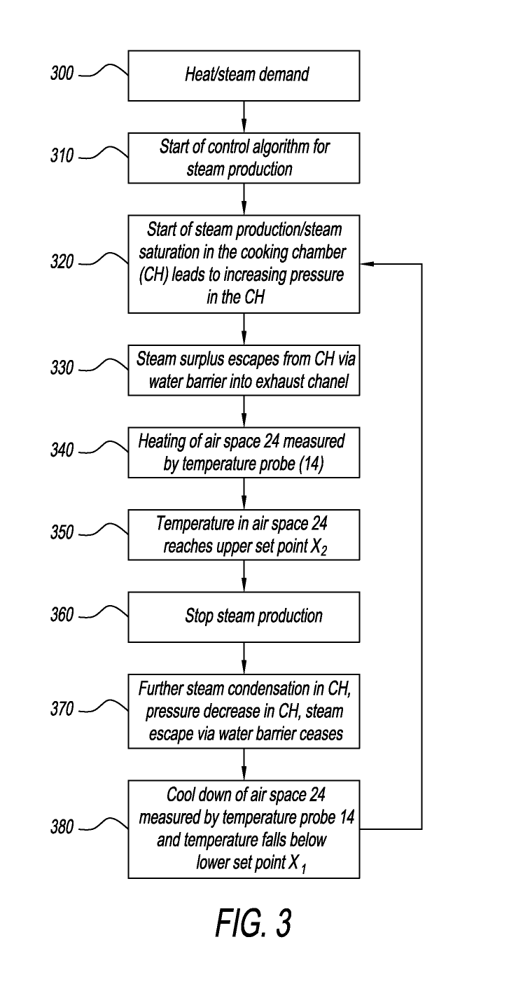

FIG. 3 shows a step-wise process according to the present disclosure. In step 300 a demand for heat and/or steam is made, such as by entry of a cooking cycle for a food product that has been placed in cooking chamber 1 of cooking device 100. In step 310, a control algorithm that reflects, in part, steam production for the cooking cycle entered in step 300 is started. In step 320, steam production by steam generator 19 is commenced and steam is provided to cooking chamber 1. As noted above, with respect to FIG. 2, the steam produced and provided to cooking chamber 1 initially condenses on the surface of the food product in cooking chamber 1. As more steam is produced and provided to cooking chamber 1, the pressure increases in cooking chamber 1. As reflected in step 330, due to increasing pressure (as noted in step 320) surplus steam escapes from cooking chamber 1 via the drain pipe 2 and through water barrier 21 and out vent pipe 4. In step 340, as the pressure increases in cooking chamber 1, the steam surplus escaping from the cooking chamber down drain pipe 2, through water barrier 21 and into vent pipe 4 increases the temperature of air space 24. In step 340, the increasing temperature is measured by temperature sensor 14. In step 350 at some point in the process, temperature sensor 14 reads that the temperature reaches a predetermined upper level (here identified as “set point X₂”). At this point, in step 360, temperature sensor 14 signals steam generator 19 via the controller to stop steam production. Thereafter, as shown in step 370, steam continues to condense in cooking chamber 1, pressure decreases in cooking chamber 1, and the escape of steam through water barrier 21 ceases. The result is that, as reflected in step 380, drain pipe 2 cools down and, at some point, the temperature falls below the lower predetermined lower level, here “set point X₁”. At this point, temperature sensor 14 signals steam generator 19 to again begin producing and providing steam to cooking chamber 1 as in step 320. The cycling between steps 320 to 380 continues until the cooking cycle in steam mode for the food product in cooking chamber 1 is complete.

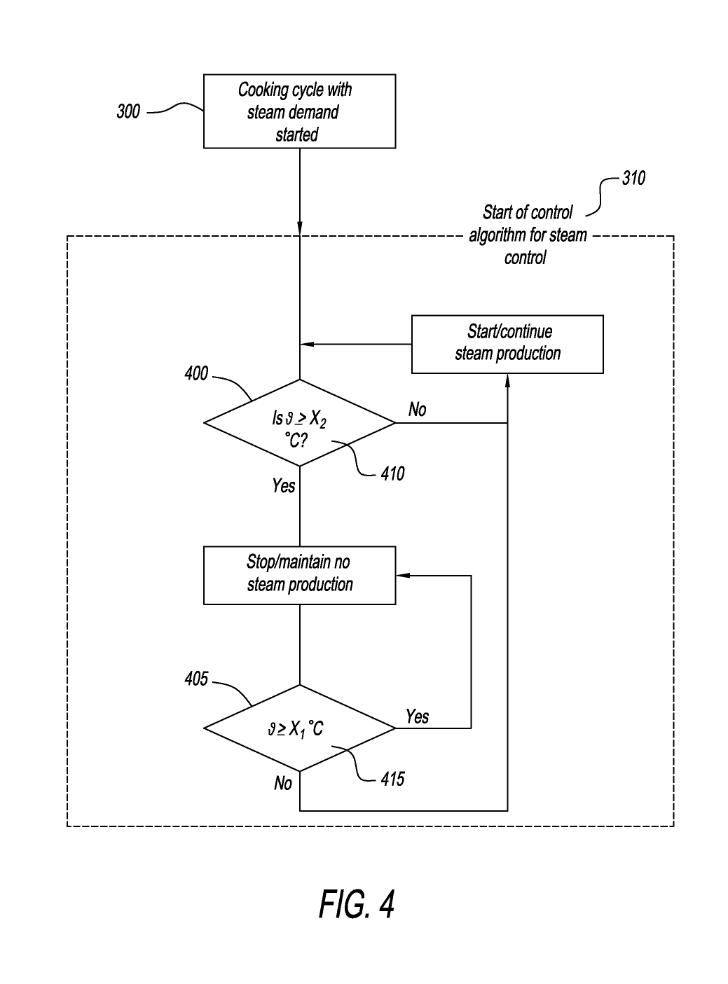

FIG. 4 shows an alternative way of looking at the process shown in FIG. 3. FIG. 4 shows the process in more of a continuous, looped cycle, decision-tree type mode. In FIG. 4, steps 300 and 310 for the demand for heat and/or steam, such as by entry of a cooking cycle requiring steam for a food product that has been placed in cooking chamber 1 of cooking device 100, and entry of a control algorithm that reflects, in part, steam production for the cooking cycle entered in step 300, remain the same, respectively, as in FIG. 3. In FIG. 4, step 310 is shown as dashed line indicating that the control algorithm for steam production is stored in a controller (not shown). In FIG. 4, at temperature sensor 14, that is always reading the temperature of the air space 24 in condenser 3, a decision point 400 is applied. At decision point 400, a question is asked and, depending upon the temperature read by temperature sensor 14, two actions are possible. The question 410 is: Is the temperature read by temperature sensor 14 greater than or equal to the predetermined upper level X₂? If the answer to question 410 is “No”, the system loops back to a point prior to decision point 400, and steam production is started or continued by temperature sensor 14 via the controller. If the answer to question 410 is “Yes”, steam generator 19 is turned off and steam production is ceased. At decision point 405, a question 415 is asked and, depending upon the temperature read by temperature sensor 14, two actions are possible. The question 415 is: Is the temperature read by temperature sensor 14 greater than or equal to the predetermined lower level X₁? If the answer to question 415 is “No”, steam production is started or continued. If the answer to question 415 is “Yes”, steam generator 19 remains turned off and there is no steam production. In this manner, similar to the process as shown in FIG. 3, the process continues to loop through decision points 400 and 405 until the cooking cycle requiring steam for the food product in cooking chamber 1 is complete or interrupted.

In the above detailed description, specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the present disclosure is not limited to the specific embodiments described above but, rather, the present disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

All of the patents, publications and other documents referred to herein are incorporated herein in their entirety as if fully set forth verbatim herein.

What is claimed is:

1. A cooking device having a cooking chamber, a drain pipe having two ends, one end disposed in communication with the cooking chamber and the other end disposed in communication with a condenser located outside of the cooking chamber, the condenser having a water level therein, the water level forming a water barrier, a waste water pipe, a vent pipe leading from the condenser to the outside environment and a temperature sensor for detecting a temperature in communication with a controller,
wherein the end of the drain pipe disposed in communication with the condenser is below the water level so as to form a closed system such that heated and/or humid air in the cooking chamber cannot exit the cooking chamber without passing through the water barrier, and
wherein the temperature sensor is disposed in the condenser in an air space above the water level and proximal the drain pipe.

2. A cooking device according to claim 1, the cooking device further having a steam generator, the steam generator in direct communication with the cooking chamber, and the temperature sensor is in communication with the steam generator,
wherein when the temperature sensor detects a pre-determined lower temperature in the air space, the temperature sensor activates the steam generator via the controller to produce and provide steam to the cooking chamber, and
wherein when the temperature sensor detects a predetermined upper temperature in the air space, the temperature sensor deactivates the steam generator to cease producing and providing steam to the cooking chamber.

3. A cooking device according to claim 1, wherein the temperature sensor is disposed in the air space above the water level from about 10 mm to about 80 mm from the drain pipe.

4. A cooking device according to claim 1, wherein the temperature sensor is shielded so that it does not come into contact with the water level.

5. A cooking device according to claim 2, wherein the predetermined upper temperature is from about 0.5K to about 20K greater than the predetermined lower temperature.

6. A cooking device according to any of claim 2, wherein the predetermined upper temperature is from about 1K to about 5K greater than the predetermined lower temperature.

7. A process for operating a cooking device having a cooking chamber, a steam generator in direct communication with the cooking chamber, a drain pipe having two ends, one end disposed in communication with the cooking chamber and the other end disposed in communication with a condenser located outside of the cooking chamber, the condenser having a water level therein, the water level forming a water barrier, a waste water pipe, a vent pipe leading from the condenser to the outside environment and a temperature sensor for detecting a temperature in communication with a controller, the process comprising:
providing that the end of the drain pipe disposed in communication with the condenser is below the water level so as to form a closed system such that heated and humid air in the cooking chamber cannot exit the cooking chamber without passing through the water barrier,
providing that the temperature sensor is disposed in the condenser in an air space above the water level and proximal the drain pipe,
starting a cooking cycle in a steam mode for cooking a food product in the cooking chamber,
starting the steam generator to provide steam to the cooking chamber,
allowing excess steam to exit the cooking chamber via the drain pipe and through the water barrier when the cooking chamber is filled with steam,
measuring the temperature of the air space by the temperature sensor,
stopping the steam generator when the temperature sensor detects a predetermined upper temperature in the air space, and
starting the steam generator when the temperature sensor detects a predetermined lower temperature in the air space.

8. A process according to claim 7, further comprising:
detecting by the temperature sensor a pre-determined lower temperature in the air space and activating the steam generator via the controller to produce and provide steam to the cooking chamber, and
detecting by the temperature sensor a predetermined upper temperature in the air space and deactivating the steam generator via the controller to cease producing and providing steam to the cooking chamber.

9. A process according to claim 7, further comprising:
disposing the temperature sensor in the air space above the water level from about 10 mm to about 80 mm from the drain pipe.

10. A process according to any of claim 7, further comprising:
shielding the temperature sensor so that it does not come into contact with the water level.

11. A process according to claim 8, further comprising:
setting the predetermined upper temperature from about 0.5K to about 20K greater than the predetermined lower temperature.

12. A process according to any of claim 8, further comprising:
setting the predetermined upper temperature from about 1K to about 5K greater than the predetermined lower temperature.
